(19) United States
(12) Patent Application Publication
(10) Pub. No.: US 2014/0075764 A1
(43) Pub. Date: Mar. 20, 2014

(54) Baby bottle nipple clipper

(71) Applicant: Catherine Consuelo Cuba, Monterey Park, CA (US)

(72) Inventor: Catherine Consuelo Cuba, Monterey Park, CA (US)

(21) Appl. No.: 13/507,579

(22) Filed: Sep. 18, 2012

(51) Int. Cl. B26F 1/32; B26F 1/24

(52) U.S. Cl. 30/366; 30/358

(57) ABSTRACT

A low cost and simple device (10) is provided for forming a hole (51) of precise size in a baby bottle nipple (12). The device includes a hollow cylinder (24) with a vertical axis (28), a plunger (14) that slides vertically in the cylinder, and a cap (32) that lies over the housing and that traps the nipple between the cap and the housing. When a person presses up a bottom (44) of the plunger, a tapered needle (22) at the top of the plunger penetrates up though the nipple to enlarge the hole in it.

### BACKGROUND OF THE INVENTION

A baby may drink milk by sucking a rubber nipple lying on the top of a bottle. When the baby is very young, the hole in the nipple should be small to avoid overfeeding and to provide sucking exercise for the baby. The size of the nipple hole should be adjusted with variation in viscosity of the formula, breast milk, milk with added cereal, baby jar food, etc. However it may be very difficult for a person to precisely increase the size of the nipple hole. Many mothers, especially in poor areas, find it expensive to buy new baby bottle nipples, or new baby bottles, in order to have a nipple with the proper size hole at any given time.

### SUMMARY OF THE INVENTION

In accordance with one embodiment of the invention, a low cost device is provided that enables a person to precisely form holes in baby bottle nipples. The device includes a plunger that is slideable along a vertical axis in a housing, the plunger having a tapered needle at the top for puncturing the baby bottle nipple. A cap lies at the top of the housing to hold down the nipple. The cap has a cap hole for passing the needle and has side walls that hold the nipple in place by friction. That is, a vertical wall of the nipple is compressed between a vertical surface of the cap and a vertical surface of the housing.

The plunger extends below the bottom of the housing, and a coil spring biases the housing relatively downward. The plunger can be moved up relative to the housing by pressing the plunger bottom down against a horizontal table surface. It also can be moved up by squeezing between a thumb against the bottom of the plunger and fingers against the top of the cylinder. The housing has a vertical plunger slot with markings beside the slot. The plunger has a cross pin that extends though a plunger hole. A person selects a nipple hole size by depressing the housing until the cross pin reaches the selected plunger marking.

The novel features of the invention are set forth with particularity in the appended claims. The invention will be best understood from the following description when read in conjunction with the accompanying drawings.

### BRIEF DESCRIPTION OF THE DRAWINGS

FIG. 1 is an exploded isometric view of a hole-forming device of the invention.

FIG. 2 is a left side elevation view of the device of FIG. 1 is a fully assembled position.

FIG. 3 is a plan view of the device of FIG. 2.

FIG. 4 is a front elevation view of the device of FIG. 2.

FIG. 4A is sectional view taken on line A-A of FIG. 4.

FIG. 5 is a side elevation view of the plunger of the device of FIG. 1.

FIG. 6 is a sectional view of the cap, housing, and a nipple, assembled to form a hole in the nipple.

### DESCRIPTION OF THE PREFERRED EMBODIMENTS

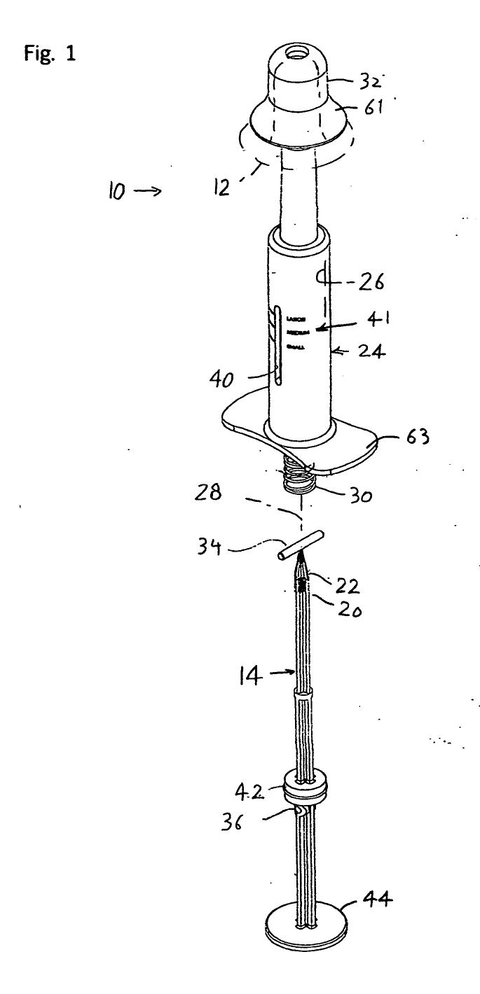

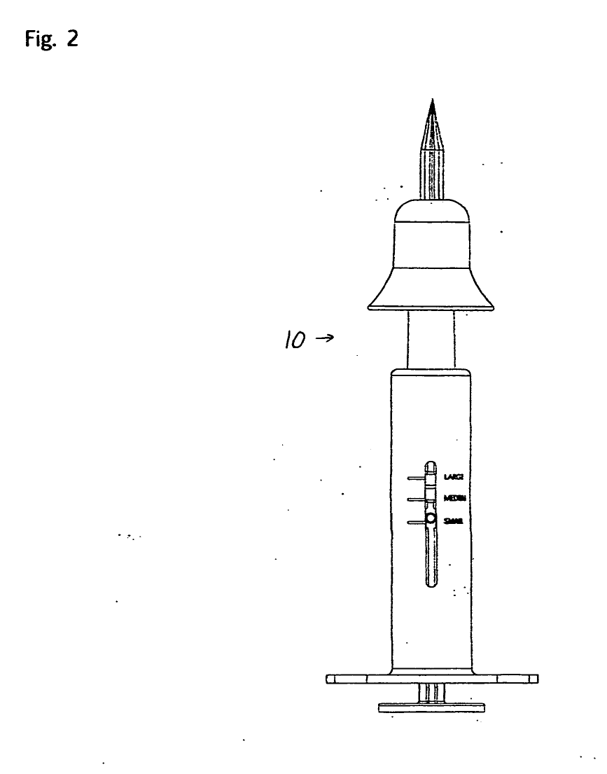

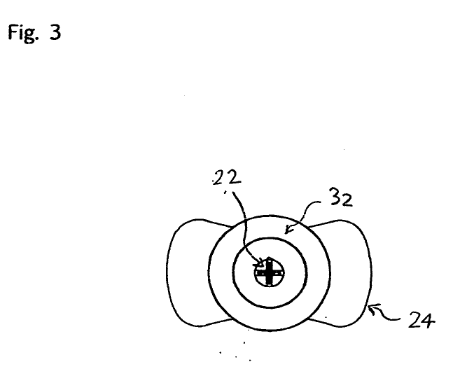

FIG. 1 shows a device 10 of the invention, ready to be assembled to form a hole of desired size in a baby bottle nipple 12. The device includes a plunger 14 that forms a needle 20 with a tapered end portion 22, a cylinder 24 that has a bore 26 with a primarily vertical axis 28 for receiving the plunger, and a coil spring 30 that biases the plunger downward when it is assembled in the cylinder. The needle is a hole cutter that can cut a hole in a nipple and can be of a variety of shapes. A cap 32 holds the nipple in place while the plunger and needle move relative to the cylinder. A cross pin 34 is designed to be press-fitted into a hole 36 of the plunger and preferably to project out of a vertical slot 40 in the cylinder. The cylinder has markings 41 that indicate the size of the hole. In FIG. 1 the markings are “large”, “medium” and “small”. The plunger has a stopper 42 that limits upward movement of the plunger relative to the cylinder.

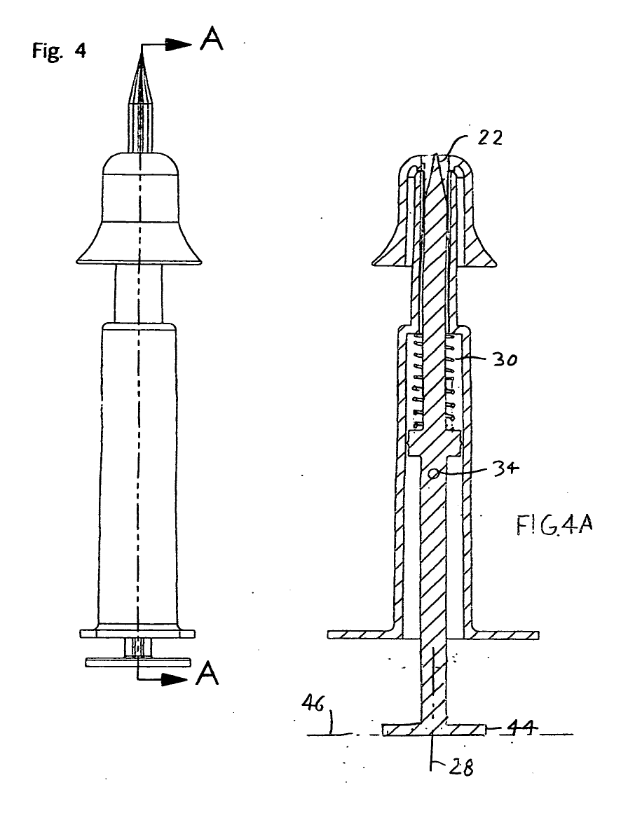

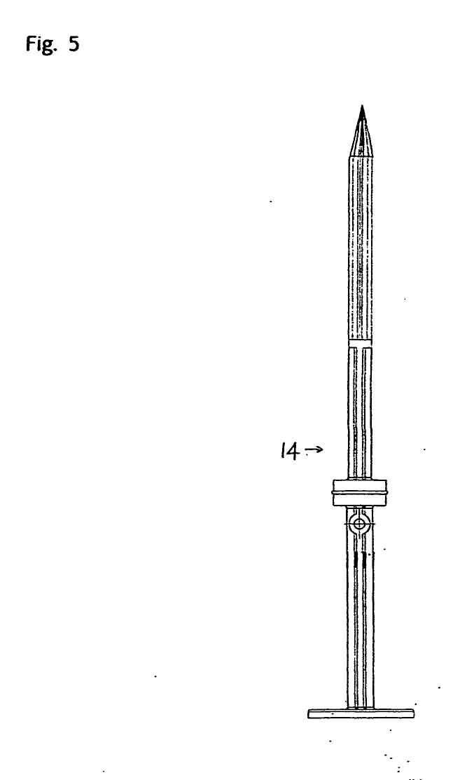

FIG. 4A shows the device after it has been assembled. When the bottom 44 of the plunger is pressed up relative to the cylinder, the plunger moves upward while compressing the spring 30, This causes the tapered needle upper portion 22 to penetrate the nipple and produce a nipple hole of a size dependent upon how far up the cross pin has moved relative to the slot 40 (FIG. 1). Needle movement can be controlled by downward force of the plunger bottom against a table top. As an alternative, a person's thumb can be placed against the bottom of the plunger and his index and middle fingers placed against the top of the cylinder, and the locations squeezed together. The cap has a downwardly-flared lower half 61 and the cylinder has wing portions 63, to facilitate such plunger movement.

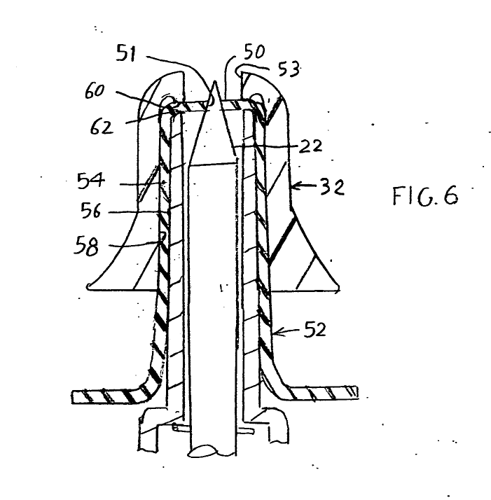

FIG. 6 shows that an upper portion 50 of the baby bottle nipple lies under the tip 22 of the needle or with the needle top passing though a nipple hole 51 and at least partially through a cap hole 53. Another portion 54 of the nipple is trapped between a cylinder vertical outer surface 56 and a cap vertical inner surface 58. The nipple is formed of elastomeric material, and can be squeezed between the vertical surfaces 56, 58. This produces high frictional resistance to sliding of the nipple. The nipple can be slid down around the housing vertical surface 56, and then the cap can be forced down around the nipple. The cap and cylinder have vertically facing opposite top surfaces 60,62 that trap a middle portion of the nipple in place. Friction between the vertical surfaces 56, 58 and the nipple side walls occurs due to bending of the nipple walls even if there is a slight gap of less than one and one-half the nipple wall thickness between surfaces 60, 62.

The housing and plunger can be formed of molded plastic in a manner similar to a hypodermic needle housing and plunger, and the needle can be the needle of a hypodermic needle. This allows the device to be constructed at low cost. Although the housing bore is usually vertical, it can function in any orientation.

Thus, the invention provides a device of simple and low cost design that can be used to form a hole or enlarge a hole in a baby bottle nipple. The device includes a plunger with a needle having a tapered upper end, the plunger being slidable in a vertical passage of a housing or cylinder. A nipple is held on the upper end of the housing by a cap that assures that a nipple upper portion is held and preferably compressed between primarily vertical surfaces of the cylinder and of the cap. The plunger has a downward projecting stopper that can be pressed upward to control the vertical position of the needle. Instead of holding the device with its axis 28 vertical, the axis can be horizontal or at any other angle.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. Apparatus for forming a nipple hole of precise diameter in a baby bottle nipple comprising:
a housing (24) having a first axis (28);
a plunger (14) that is slideable in said housing along said first axis, said plunger having a needle with a needle front end (22) that is sharp for penetrating said nipple to form said hole;
cap means (32) mounted on said housing for holding down the nipple, said cap means having a hole (53) lying on said first axis for passing said needle front end.

2. The apparatus described in claim 1 wherein:
said nipple is formed of elastomeric material and is radially compressed between surfaces (56, 58) of said housing and of said cap means.

3. The apparatus described in claim 1 wherein:
said plunger axis extends primarily vertically and has a wide bottom end (44) for pressing against a table surface (46);
a coil spring (30) that has opposite ends, including a first end that abuts said plunger and a second end that abuts said housing, said coil spring urging said plunger downward, so the needle front end can be pressed up partially through the nipple by moving down the housing while preventing downward movement of the plunger.

4. The apparatus described in claim 3 wherein:
said housing has a vertical indicator slot (40); and
a cross pin that is fixed to said plunger and that projects through said slot, said housing having markings to indicate the cross pin height.

5. A device for forming a hole of precisely controlled size in a baby bottle nipple, comprising:
a housing having a vertical bore (26);
a plunger that extends through said bore and that is slideable in said bore, said plunger having an upper end that forms a hole cutter (22) and said plunger having a lower end;
a cap (32) that mounts said baby bottle nipple on said housing, said cap having an inside diameter, said nipple formed of elastomeric material and lying radially compressed between an outside surface (56) of said housing upper portion and an inside surface (58) of said cap.

6. The device described in claim 5 wherein:
said cap means comprises a cap with an outward-downward flared lower portion (61) to facilitate pushing down the cap while the plunger moves up.

7. The device described in claim 6 wherein:
said cap has an upper end with a primarily vertical cap surface (58), and said housing upper end portion has a primarily vertical housing surface (56) lying opposite said cap surface;
the space between said cap and housing surfaces is small enough to compress a location on said nipple between them.

8. The device described in claim 7 wherein:
said cap upper end has a part (60) that projects downward, whereby to trap the nipple close to its upper end.
